(19) United States
(12) Patent Application Publication
(10) Pub. No.: US 2018/0096390 A1
(43) Pub. Date: Apr. 5, 2018

(54) SYSTEMS AND METHODS FOR PROMOTING CONTENT ITEMS

(71) Applicant: Facebook, Inc., Menlo Park, CA (US)

(72) Inventors: Hannah Marie Hemmaplardh, Seattle, WA (US); James Wah Hou Wong, Bellevue, WA (US); Jinyi Yao, Issaquah, WA (US)

(21) Appl. No.: 15/282,925

(22) Filed: Sep. 30, 2016

(51) Int. Cl. G06Q 30/02; G06Q 50/00; G06F 17/30; G06N 99/00

(52) U.S. Cl. CPC G06Q 30/0255; G06N 99/005; G06F 17/30887; G06Q 50/01

(57) ABSTRACT

Systems, methods, and non-transitory computer-readable media can determine at least one content item to be promoted to one or more users. One or more tokens that describe the content item are determined. A set of interests are determined based at least in part on the one or more tokens using a trained machine learning model. At least one first interest from the set as a suggestion is provided for promoting the content item to users, wherein promoting the content item using the first interest causes the content item to be presented to users that are associated with the first interest.

### FIELD OF THE INVENTION

The present technology relates to the field of content promotion. More particularly, the present technology relates to techniques for promoting content items.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

In some instances, advertisements can be presented to users of the social network. Advertisements may be linked to various content items, such as websites, for example. Typically, the advertisements presented to users can be tailored, for example, based on topics that are determined to be of interest to the user. Often, the advertisement includes a hypertext link or other user-selectable element that enables the user to navigate to another page or display relating to the advertisement.

### SUMMARY

Various embodiments of the present disclosure can include systems, methods, and non-transitory computer readable media configured to determine at least one content item to be promoted to one or more users. One or more tokens that describe the content item are determined. A set of interests are determined based at least in part on the one or more tokens using a trained machine learning model. At least one first interest from the set as a suggestion is provided for promoting the content item to users, wherein promoting the content item using the first interest causes the content item to be presented to users that are associated with the first interest.

In an embodiment, the content item is one of a page accessible through a social networking system or a post that is accessible through a social networking system.

In an embodiment, the systems, methods, and non-transitory computer readable media are configured to determine the one or more tokens from text associated with in the content item.

In an embodiment, the text corresponds to at least one of: a description of a page, a title of a page, or text in a post.

In an embodiment, the systems, methods, and non-transitory computer readable media are configured to determine at least one category associated with the content item and determine the one or more tokens based at least in part on the category.

In an embodiment, the systems, methods, and non-transitory computer readable media are configured to determine the one or more tokens from at least one media item included in the content item.

In an embodiment, the systems, methods, and non-transitory computer readable media are configured to determine at least one Uniform Resource Locator (URL) in the content item and determine the one or more tokens based at least in part on the URL.

In an embodiment, the systems, methods, and non-transitory computer readable media are configured to determine at least one Uniform Resource Locator (URL) in the content item and determine the one or more tokens based at least n part on content that is referenced by the URL.

In an embodiment, the systems, methods, and non-transitory computer readable media are configured to train the machine learning model to determine interests for content items, wherein the model is trained to predict interests for a first content.

In an embodiment, the model is a supervised text embedding model that is trained to learn embeddings that relate tokens to interests.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example promotion module for promoting content items, according to an embodiment of the present disclosure.

FIG. 2 illustrates an example of an interest suggestion module, according to an embodiment of the present disclosure.

FIG. 3 illustrates an example of a model training module, according to an embodiment of the present disclosure.

FIG. 4 illustrates an example of an interface through which a content item can be promoted, according to an embodiment of the present disclosure.

FIG. 5 illustrates an example process for generating interests for promoting a content item, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Promoting Content Items

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

In some instances, a promoter (e.g., advertiser) may seek to promote a content item to users of the social networking system. When being promoted, the content item can be presented to other users, for example, as an advertisement or suggestion. The promoted content item can include various information including, for example, a link for accessing information related to the content item. In various embodiments, the content item being promoted may be a page that is accessible through the social networking system, a website (or Uniform Resource Locator) associated with a page that is accessible through the social networking system, and/or a post that is accessible through the social networking system. A page may relate to an entity (e.g., a business, topic, location, user, etc.). Users of the social networking system can navigate to the page to learn more about the entity as well as access and/or post content (e.g., text and/or media content items, such as images, videos, and audio) through the page. Users of the social networking system have the option to be associated with the page, for example, by “liking” the page (e.g., selecting a “like” option through the social networking system). A user that is associated with a page can be referred to as a fan or someone who has fanned the page. A post may be a content item (e.g., text, media, etc.) that is published by a user through the social networking system. Posts can be surfaced through a page or newsfeed. Further, users can interact with posts, for example, by posting comments or replies, selecting a like option in response to the post, selecting a reaction option in response to the post, and/or sharing the post.

Typically, a user can promote a content item by specifying a set of interests to be targeted as well as a spending budget for promoting the content item. The content item can then be promoted through the social networking system to users that have specified, or demonstrated, any of the specified interests. For example, a content item can be associated with the interests “camping”, “backpacking”, and “outdoors” and a daily spend of $10 may be allotted for promoting the content item. In this example, promotion of the content item can be targeted at users of the social networking system that have specified, or demonstrated, an interest in at least one of “camping”, “backpacking”, and “outdoors”. The content item can continue to be promoted until the daily spending budget of $10 has been exhausted. As evident, the interests specified for a content item can play an important role in effectively promoting that content item to the appropriate user audience. However, the task of determining which interests are appropriate for content items can be difficult for some users, especially those that are unsophisticated in terms of promoting content items. Under conventional approaches, therefore, users seeking to promote content items may end up specifying sub-optimal interests for promoting the content items, thereby resulting in ineffective targeting of users and wasted resources. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, interests can be automatically suggested to users based on the content item being promoted. For example, a user seeking to promote a page for their coffee shop can be provided “latte”, “café”, and “pastries” as a set of suggested interests. The promoter has the option to accept or decline any of the suggested interests for purposes of promoting the page. As a result, the improved approach can provide users with a set of suggested interests for promoting any given content item, thereby effectively targeting the appropriate user audience while optimizing the use of spend.

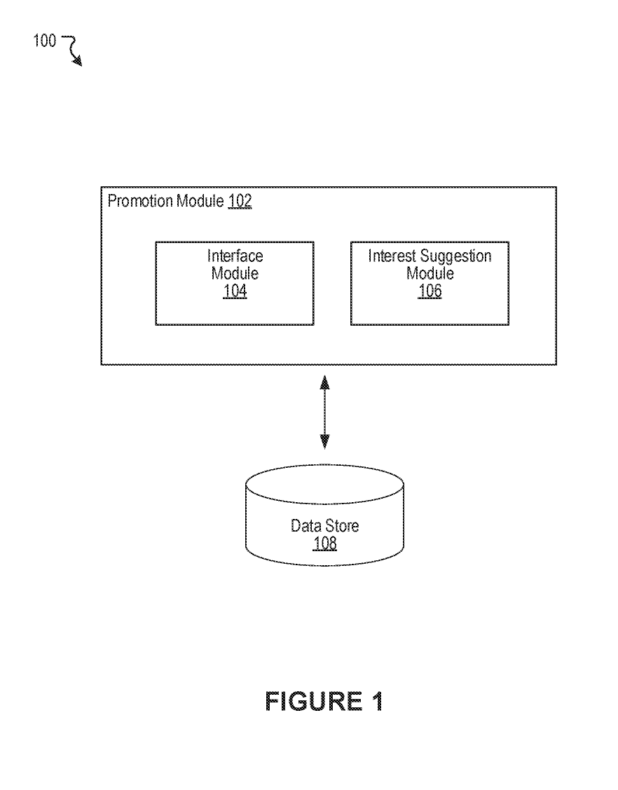

FIG. 1 illustrates an example system 100 including an example promotion module 102 for promoting content items, according to an embodiment of the present disclosure. As shown in the example of FIG. 1, promotion module 102 can include an interface module 104 and an interest suggestion module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

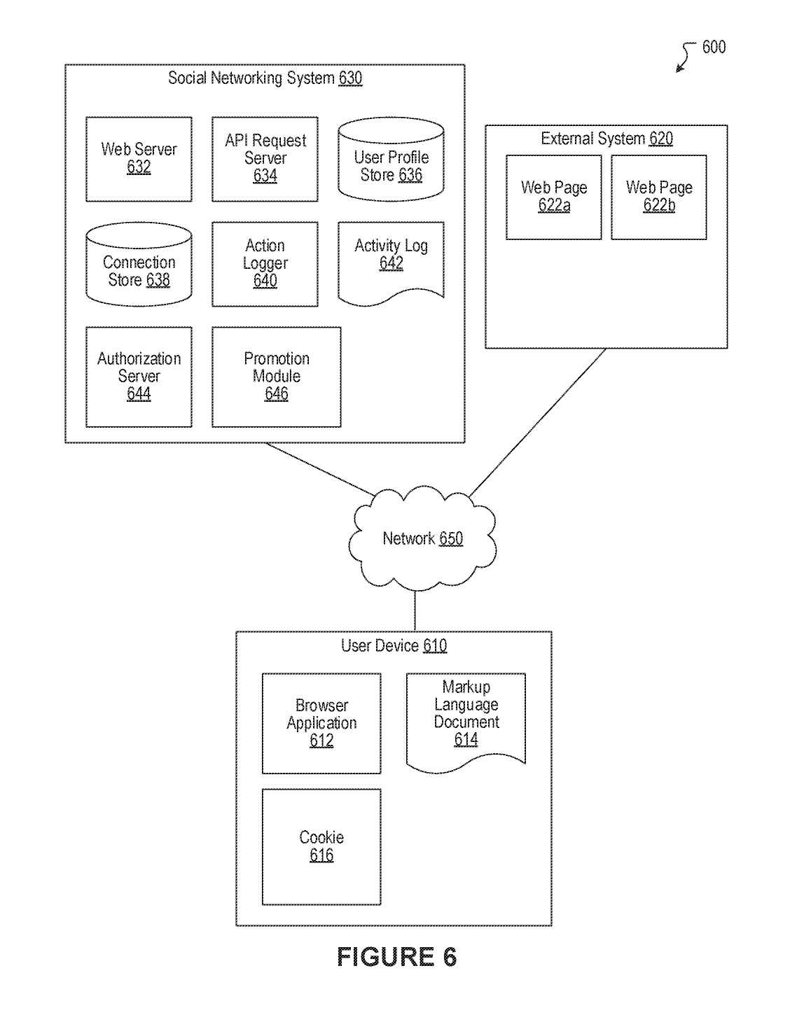

In some embodiments, the promotion module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the promotion module 102 can be implemented, in part or in whole, as software running on one or more computing devices or systems, such as on a user or client computing device. In one example, the promotion module 102 or at least a portion thereof can be implemented as or within an application (e.g., app), a program, or an applet, etc., running on a user computing device or a client computing system, such as the user device 610 of FIG. 6. In another example, the promotion module 102 or at least a portion thereof can be implemented using one or more computing devices or systems that include one or more servers, such as network servers or cloud servers. In some instances, the promotion module 102 can, in part or in whole, be implemented within or configured to operate in conjunction with a social networking system (or service), such as the social networking system 630 of FIG. 6.

The promotion module 102 can be configured to communicate and/or operate with the at least one data store 108, as shown in the example system 100. The at least one data store 108 can be configured to store and maintain various types of data including respective interests that have been utilized for promoting content items over various periods of time and/or data corresponding to a trained model for predicting interests for content items based on a respective set of tokens that describe those content items. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data.

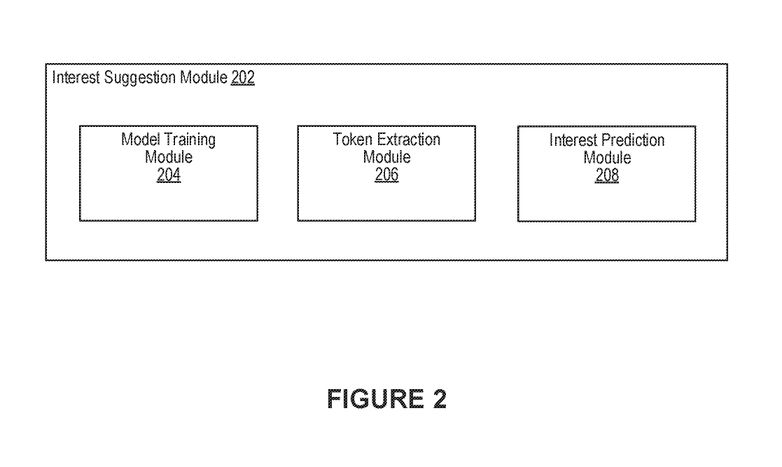

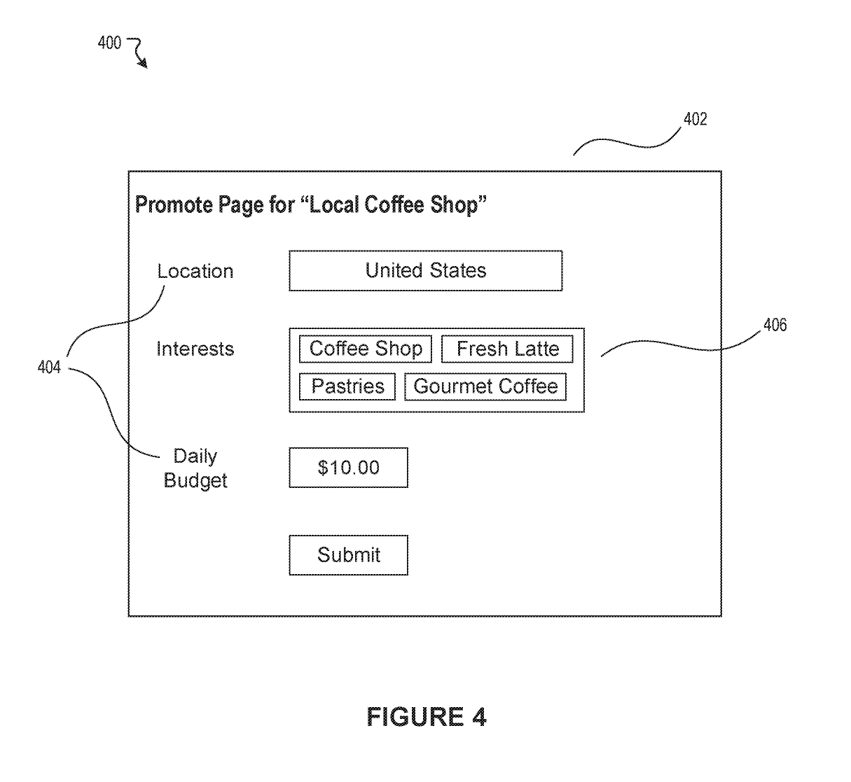

In various embodiments, the interface module 104 can be configured to provide an interface through which a user can promote content items. In various embodiments, upon selecting a content item to promote, the user can be provided, through the interface, a set of suggested interests to use for promoting the content item. More details regarding the interface will be provided below with reference to FIG. 4. The interest suggestion module 106 can be configured to determine suggested interests for content items. For example, the interest suggestion module 106 can utilize various information, such as the content item to be promoted, to determine a set of interests that may be used to effectively target the content item to an appropriate user audience. More details regarding the interest suggestion module 106 will be provided below with reference to FIG. 2.

FIG. 2 illustrates an example of an interest suggestion module 202 configured to generate user interests for a content item, according to an embodiment of the present disclosure. In some embodiments, the interest suggestion module 106 of FIG. 1 can be implemented as the interest suggestion module 202. As shown in FIG. 2, the interest suggestion module 202 can include a model training module 204, a token extraction module 206, and an interest prediction module 208.

As mentioned, the interest suggestion module 202 can be configured to determine a set of suggested interests for a content item being promoted. One or more of the suggested interests may be then selected for use in promoting the content item. These selected interests can be utilized by the social networking system to promote, or target, the content item to users that have specified, or demonstrated, those interests.

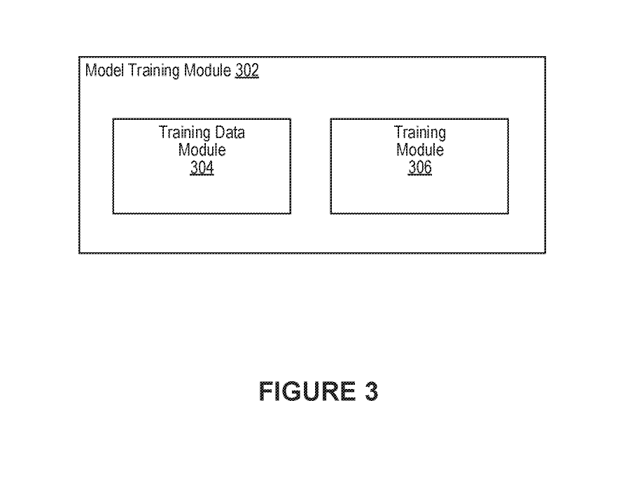

In various embodiments, the model training module 204 is configured to train a model for determining interests for a content item being promoted. In some embodiments, the trained model determines the interests for the content item based on any tokens that were determined, or extracted, from the content item using the approaches described herein. More details regarding the model training module 204 will be provided below with reference to FIG. 3.

In some embodiments, the token extraction module 206 generates a set of tokens for a content item being promoted through the social networking system. Each token can be made up of one or more terms that describe some aspect of the content item. Some examples of the types of content items that may be promoted include, for example, pages, posts, or other types of content items that can be published through the social networking system.

In some embodiments, when promoting a page, the token extraction module 206 is configured to determine one or more tokens from a title of the page. In some embodiments, the token extraction module 206 can generate the tokens by splitting the page title into terms. For example, a page title “Bob's Deep Sea Fishing Expeditions” can be split into the following tokens: “Bob's”, “Deep”, “Sea”, “Fishing” and “Expeditions”. In some embodiments, the page title can be split into n-grams of various specified lengths.

In some embodiments, the token extraction module 206 determines tokens from any categories in which the page has been categorized. For example, content items, e.g., pages, can be categorized into one or more categories based on their subject matter and/or the entity (e.g., a business, topic, location, user, etc.) associated with the content item. In one example, a page for a coffee shop can be associated with the categories “restaurant”, “workspace”, and “food and beverage”. In some embodiments, the token extraction module 206 includes some, or all, of these categories in the set of tokens that describe the page. In this example, the set of tokens for the coffee shop page would include “restaurant”, “workspace”, and “food and beverage”. In some instances, it may be useful to distinguish the tokens that are determined from a page's categories from tokens that are determined from other content related to the page. Thus, in some embodiments, a token corresponding to a category can be appended with an identifier that references the category. For example, a category “workspace” may be identified by the social networking system using an identifier 5221. In this example, the token corresponding to this category would be “workspace5221” (or some other string variation that includes both the category and identifier, e.g., “workspace_5221”).

In some embodiments, the content item (e.g., page, post, post published through the page, etc.) to be promoted may include media items (e.g., images, videos, audio, etc.). In such embodiments, the media items can be analyzed to determine a set of corresponding tokens that describe the respective subject matter that is captured by each of the media items. In some embodiments, a media item can be analyzed by applying a machine learning model (content classifier) to the media item. The content classifier can determine a probability indicating whether the media item reflects predetermined subject matter (e.g., objects, scenery, time of day, location, etc.). For example, the content classifier may predict the tokens “coffee” and “coffee cup” in response to an image of a coffee cup. In this example, the tokens “coffee” and “coffee cup” can both be included in the set of tokens that describe the content item to be promoted. A content item may include more than one media item (e.g., multiple images, videos, etc.). In such instances, one or more tokens can be determined from each of these media items. In some embodiments, tokens that are determined from multiple media items in a content item can be filtered to include only those tokens that appear at least a threshold amount of times (e.g., threshold number, percentage, etc.). For example, a set of tokens determined for a content item may include one instance of the token “coffee” (e.g., determined from a first media item) and two instances of the token “coffee cup” (e.g., determined from the first media item and a second media item). In this example, if the threshold requires that a token determined for a content item have more than one instance, then the set of tokens for the content item would include the token “coffee cup” but not “coffee”, since there are two instances of the token “coffee cup” and only one instance of the token “coffee”.

In general, the content classifier can be based on any machine learning technique, including but not limited to a deep convolutional neural network. For example, the content classifier can be trained and tested to determine the subject matter reflected by media items. In a development phase, contextual cues for a sample set of media items can be gathered. Media classes (or categories) corresponding to various subject matter can be determined. Correlation of the sample set of media items with the media classes based on the contextual cues can be determined. A training set of media items can be generated from the sample set of media items based on scores indicative of high correlation. The training set of media items can be used to train the content classifier to generate visual pattern templates of the media classes. In an evaluation phase, the content classifier can be applied to a new media item to determine the subject matter reflected by the new media item. The output from the content classifier can be used as tokens that describe the subject matter captured by the new media item.

In some embodiments, the token extraction module 206 determines tokens from a description of the page. For example, an administrator of a page may provide a description of the page's focus or purpose. This description can be made available in the page as published through the social networking system. In some embodiments, this description can be provided to an entity extractor (e.g., topic tagger) for analysis. The entity extractor can provide a set of topics that were determined from the description as well as a respective value that indicates the likelihood, or confidence, with which a topic corresponds to the page's description. In some embodiments, the topics having at least a threshold likelihood are included in the set of tokens that describe the page. The entity extractor can be implemented using any generally known techniques for extracting topics from text.

In some embodiments, the token extraction module 206 determines tokens from one or more Uniform Resource Locators (or URLs) that are associated with the page. For example, a page may include links (or URLs) to external content (e.g., a website). In this example, the token extraction module 206 can determine tokens from any portion of the URLs associated with the page. In one example, the token extraction module 206 can determine the token “example” from the URL “http://www.example.com”. In some embodiments, the token extraction module 206 can scrape any text from the content (e.g., website) referenced by the URL. This scraped text can be used to determine the tokens for the page. In one example, the tokens can be obtained by providing the scraped text o an entity extractor, as described above.

As mentioned, in some embodiments, posts published through the social networking system can also be promoted. In such embodiments, tokens for a post can be determined by analyzing the posts using any of the approaches described above. For example, in some instances, posts can be published through one or more pages. In such instances, tokens for the post can be determined by analyzing the pages in which the post was published using the approaches described above. Tokens for the post can also be determined based at least in part on the text (e.g., hashtags, named entities, topics, etc.) and/or media items (e.g., images, videos, audio, etc.) included in the post, as described above.

In some embodiments, any tokens determined for the content item can be provided to the interest prediction module 208. The interest prediction module 208 can determine a set of candidate interests based at least in part on the tokens using a trained model. In some embodiments, the model is trained to relate tokens to interests. For example, for the tokens “coffee shop”, “workplace”, “food and beverage”, and “San Francisco”, the interest prediction module 208 can output the candidate interests “age group 25-34”, “gourmet coffee”, and “socializing”. In some embodiments, the interest prediction module 208 generates a respective score for each candidate interest. In such embodiments, once the scores have been generated, the interest prediction module 208 can be configured to provide a ranked listing of candidate interests or a threshold number of the highest ranking candidate interests. Some, or all, of these highest ranking candidate interests can then be presented as suggested interests, for example, through a promotion user interface, as described in reference to FIG. 4.

FIG. 3 illustrates an example of a model training module 302, according to an embodiment of the present disclosure. In some embodiments, the model training module 204 of FIG. 2 can be implemented as the model training module 302. As shown in FIG. 3, the model training module 302 can include a training data module 304 and a training module 306.

In various embodiments, the training data module 304 is configured to generate training data to be used for training a model that determines candidate interests for content items. For example, the model can be trained to predict candidate interests for a content item being promoted based on one or more tokens that were determined for the content item using the approaches described above.

The training data used to train the machine learning model can include a number of training examples. In some embodiments, the training data is determined using data describing previously promoted content items and the respective interests that were used to promote those content items. In some embodiments, each training example can include a set of tokens that were determined for a previously promoted content item and the respective interests that were used to promote that content item.

The training module 306 can use these training examples to train the machine learning model. In general, any type of machine learning model may be used. In some embodiments, the model is a supervised text embedding model that is trained to learn embeddings that relate tokens to interests. One example approach for training the model is described in J. Weston, S. Chopra, and K. Adams “#TagSpace: Semantic Embeddings from Hashtags,” Proceedings of the 2014 Conference on Empirical Methods in Natural Language Processing (EMNLP), pages 1822-1827. Once trained, the machine learning model will have learned embeddings that relate tokens and interests. The trained model can then be used to determine, or predict, candidate interests for content items.

FIG. 4 illustrates an example 400 of an interface 402 through which a content item can be promoted, according to an embodiment of the present disclosure. In this example, the interface 402 is presented on a display screen of a computing device. Further, the interface 402 may be provided through an application (e.g., a web browser, a social networking application, etc.) running on the computing device. In the example of FIG. 4, a user operating the computing device can interact with the interface 402 to promote a content item (e.g., a page for “Local Coffee Shop”). When promoting the content item, the user can specify various targeting criteria 404 such as the geographic region (e.g., a region, country, state, zip code, etc.) as well as a spending budget for the promotion campaign. The user can also specify one or more interests 406. The content item can then be promoted to users that have specified, or demonstrated, any interests that match the specified interests 406. In some embodiments, the interests 406 are automatically populated in the interface 402. For example, a set of tokens can be determined for the content item using the approaches described above. In this example, these tokens can be provided to a trained model for predicting the set of interests 406 (e.g., “coffee shop”, “fresh latte”, “pastries”, and “gourmet coffee”. The promoting user has the option to accept or decline any of the suggested interests 406 or to add any additional interests to be targeted.

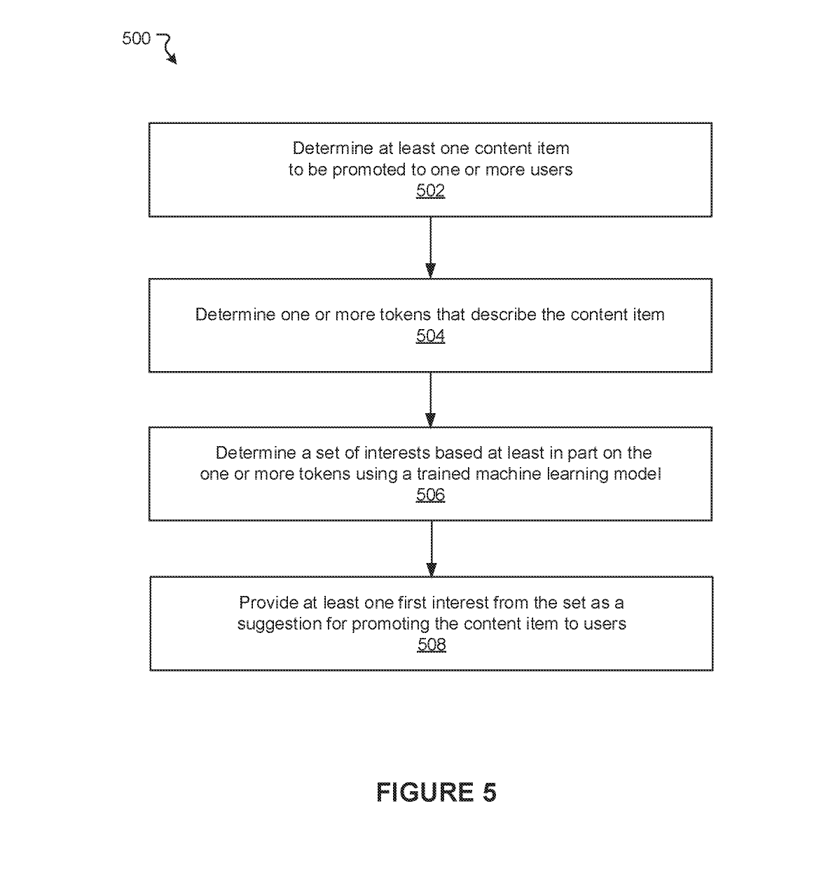

FIG. 5 illustrates an example process 500 for generating interests for promoting a content item, according to an embodiment of the present disclosure. It should be appreciated that there can be additional, fewer, or alternative steps performed in similar or alternative orders, or in parallel, within the scope of the various embodiments discussed herein unless otherwise stated.

At block 502, a determination is made that at least one content item is to be promoted to one or more users. At block 504, one or more tokens that describe the content item are determined. At block 506, a set of interests are determined based at least in part on the one or more tokens using a trained machine learning model. At block 508, at least one first interest from the set as a suggestion is provided for promoting the content item to users, wherein promoting the content item using the first interest causes the content item to be presented to users that are associated with the first interest.

It is contemplated that there can be many other uses, applications, and/or variations associated with the various embodiments of the present disclosure, For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking Social—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (VViMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution), For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a promotion module 646. The promotion module 646 can, for example, be implemented as the promotion module 102 of FIG. 1. As discussed previously, it should be appreciated that there can be many variations or other possibilities.

### Hardware Implementation

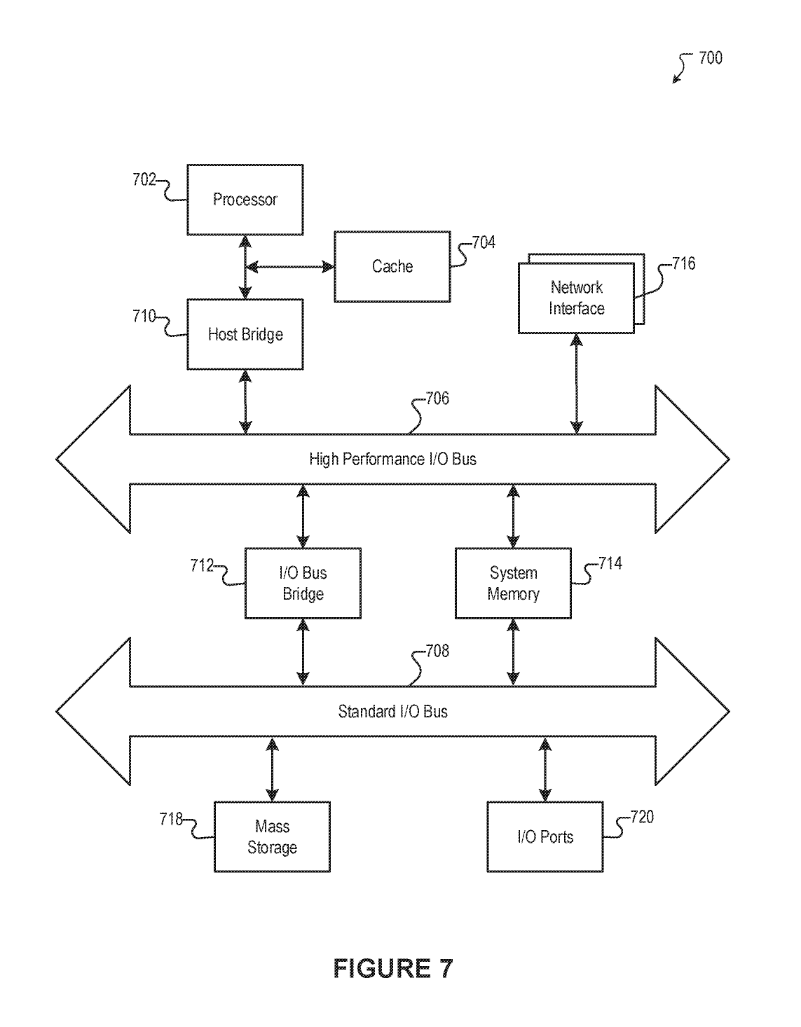

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, at least one content item to be promoted to one or more users;
determining, by the computing system, one or more tokens that describe the content item;
determining, by the computing system, a set of interests based at least in part on the one or more tokens using a trained machine learning model; and
providing, by the computing system, at least one first interest from the set as a suggestion for promoting the content item to users, wherein promoting the content item using the first interest causes the content item to be presented to users that are associated with the first interest.

2. The computer-implemented method of claim 1, wherein the content item is one of a page accessible through a social networking system or a post that is accessible through a social networking system.

3. The computer-implemented method of claim 1, wherein determining one or more tokens that describe the content item further comprises:
determining, by the computing system, the one or more tokens from text associated with in the content item.

4. The computer-implemented method of claim 3, wherein the text corresponds to at least one of: a description of a page, a title of a page, or text in a post.

5. The computer-implemented method of claim 1, wherein determining one or more tokens that describe the content item further comprises:
determining, by the computing system, at least one category associated with the content item; and
determining, by the computing system, the one or more tokens based at least in part on the category.

6. The computer-implemented method of claim 1, wherein determining one or more tokens that describe the content item further comprises:
determining, by the computing system, the one or more tokens from at least one media item included in the content item.

7. The computer-implemented method of claim 1, wherein determining one or more tokens that describe the content item further comprises:
determining, by the computing system, at least one Uniform Resource Locator (URL) in the content item; and
determining, by the computing system, the one or more tokens based at least in part on the URL.

8. The computer-implemented method of claim 1, wherein determining one or more tokens that describe the content item further comprises:
determining, by the computing system, at least one Uniform Resource Locator (URL) in the content item; and
determining, by the computing system, the one or more tokens based at least in part on content that is referenced by the URL.

9. The computer-implemented method of claim 1, wherein determining a set of interests based at least in part on the one or more tokens using a trained machine learning model further comprises:
training, by the computing system, the machine learning model to determine interests for content items, wherein the model is trained to predict interests for a first content item in response to one or more tokens that are determined from the first content item.

10. The computer-implemented method of claim 10, wherein the model is a supervised text embedding model that is trained to learn embeddings that relate tokens to interests.

11. A system comprising:
at least one processor; and
a memory storing instructions that, when executed by the at least one processor, cause the system to perform:
determining at least one content item to be promoted to one or more users;
determining one or more tokens that describe the content item;
determining a set of interests based at least in part on the one or more tokens using a trained machine learning model; and
providing at least one first interest from the set as a suggestion for promoting the content item to users, wherein promoting the content item using the first interest causes the content item to be presented to users that are associated with the first interest.

12. The system of claim 11, wherein the content item is one of a page accessible through a social networking system or a post that is accessible through a social networking system.

13. The system of claim 11, wherein determining one or more tokens that describe the content item further causes the system to perform:
determining the one or more tokens from text associated with in the content item.

14. The system of claim 13, wherein the text corresponds to at least one of: a description of a page, a title of a page, or text in a post.

15. The system of claim 11, wherein determining one or more tokens that describe the content item further causes the system to perform:
determining at least one category associated with the content item; and
determining the one or more tokens based at least in part on the category.

16. A non-transitory computer-readable storage medium including instructions that, when executed by at least one processor of a computing system, cause the computing system to perform a method comprising:
determining at least one content item to be promoted to one or more users;
determining one or more tokens that describe the content item;
determining a set of interests based at least in part on the one or more tokens using a trained machine learning model; and
providing at least one first interest from the set as a suggestion for promoting the content item to users, wherein promoting the content item using the first interest causes the content item to be presented to users that are associated with the first interest.

17. The non-transitory computer-readable storage medium of claim 16, wherein the content item is one of a page accessible through a social networking system or a post that is accessible through a social networking system.

18. The non-transitory computer-readable storage medium of claim 16, wherein determining one or more tokens that describe the content item further causes the computing system to perform:
determining the one or more tokens from text associated with in the content item.

19. The non-transitory computer-readable storage medium of claim 18, wherein the text corresponds to at least one of: a description of a page, a title of a page, or text in a post.

20. The non-transitory computer-readable storage medium of claim 16, wherein determining one or more tokens that describe the content item further causes the computing system to perform:
determining at least one category associated with the content item; and
determining the one or more tokens based at least in part on the category.
